(19) United States
(12) Patent Application Publication
(10) Pub. No.: US 2015/0035749 A1
(43) Pub. Date: Feb. 5, 2015

(54) INFORMATION PROCESSING DEVICE, INFORMATION PROCESSING METHOD, AND PROGRAM

(71) Applicant: SONY CORPORATION, Tokyo (JP)

(72) Inventors: YUSUKE NAKAGAWA, Tokyo (JP); HIROYUKI MIZUNUMA, Tokyo (JP); KUNIHITO SAWAI, Kanagawa (JP); YUHEI TAKI, Kanagawa (JP); IKUO YAMANO, Tokyo (JP); KEISUKE YAMAOKA, Tokyo (JP)

(21) Appl. No.: 14/338,024

(22) Filed: Jul. 22, 2014

(30) Foreign Application Priority Data
Jul. 30, 2013 (JP) 2013-157574

(51) Int. Cl. G06F 3/0484; G06F 3/14

(52) U.S. Cl. CPC G06F 3/0484; G06F 3/1423
USPC 345/157

(57) ABSTRACT

There is provided an information processing device including a controller configured to move a pointer within a display screen based on operation information, and a determination unit configured to determine whether the pointer is to be moved into a virtual screen set around the display screen, based on a state of the pointer when the pointer is moved to an edge of the display screen.

### CROSS REFERENCE TO RELATED APPLICATIONS

This application claims the benefit of Japanese Priority Patent Application JP 2013-157574 filed Jul. 30, 2013, the entire contents of which are incorporated herein by reference.

### BACKGROUND

The present disclosure relates to an information processing device, an information processing method, and a program.

In a technique disclosed in WO 09/72504, a virtual screen is set around a display screen (a real screen). In the technique, a pointer is moved within the display screen and the virtual screen based on the user's operation of a remote controller.

### SUMMARY

However, in the technique disclosed in WO 09/72504, even when the user does not want to move the pointer into the virtual screen, the pointer will be moved into the virtual screen. Thus, the technique disclosed in WO 09/72504 may give an uncomfortable feeling to a user who performs an input operation.

Therefore, it is desirable to provide a technology for reducing an uncomfortable feeling of a user who performs an input operation.

According to an embodiment of the present disclosure, there is provided an information processing device including a controller configured to move a pointer within a display screen based on operation information, and a determination unit configured to determine whether the pointer is to be moved into a virtual screen set around the display screen, based on a state of the pointer when the pointer is moved to an edge of the display screen.

According to another embodiment of the present disclosure, there is provided an information processing method including moving a pointer within a display screen based on operation information, and determining whether the pointer is to be moved into a virtual screen set around the display screen, based on a state of the pointer when the pointer is moved to an edge of the display screen.

According to still another embodiment of the present disclosure, there is provided a program for causing a computer to execute a control function of moving a pointer within a display screen based on operation information, and a determination function of determining whether the pointer is to be moved into a virtual screen set around the display screen, based on a state of the pointer when the pointer is moved to an edge of the display screen.

According to one or more embodiments of the present disclosure, it is possible to impose a limit on movement of a pointer to a virtual screen.

According to one or more embodiments of the present disclosure as described above, it is possible to impose a limit on movement of a pointer to a virtual screen. Thus, the user who does not want to move a pointer to a virtual screen can keep the pointer within a display screen. As a result, an uncomfortable feeling of the user who performs an input operation is reduced. Note that advantageous effects achieved by the technology according to the embodiments of the present disclosure are not limited to the effects described herein. The technology according to the embodiments of the present disclosure may have any advantageous effect described herein and other effects not stated herein.

### BRIEF DESCRIPTION OF THE DRAWINGS

FIG. 1 is a diagram illustrating the appearance of a general configuration of an information processing system according to an embodiment of the present disclosure;

FIG. 2 is a functional block diagram illustrating the configuration of an input device according to an embodiment of the present disclosure;

FIG. 3 is a diagram illustrating a hardware configuration of the input device;

FIG. 4 is a functional block diagram illustrating the configuration of the information processing device;

FIG. 5 is a diagram illustrating a hardware configuration of the information processing device;

FIG. 6 is a schematic diagram for explaining exemplary display and virtual screens;

FIG. 7 is a flowchart illustrating a procedure of processing performed by the information processing system;

FIG. 8 is a schematic diagram for explaining the position of corner parts of the display screen;

FIG. 9 is a schematic diagram for explaining an angle of entrance or the like of a pointer;

FIG. 10 is a schematic diagram for explaining a distance over which a pointer is moved in a straight line;

FIG. 11 is a schematic diagram for explaining a distance from a pointer to an object;

FIG. 12 is a schematic diagram for explaining an example of changing a display mode of a pointer image as an example of reporting a result obtained by determining whether a pointer is to be moved into a virtual screen;

FIG. 13 is a schematic diagram for explaining an example of changing a display mode of a pointer image as an example of reporting a result obtained by determining whether a pointer is to be moved into a virtual screen;

FIG. 14 is a schematic diagram for explaining an example of changing a display mode of a pointer image as an example of reporting a result obtained by determining whether a pointer is to be moved into a virtual screen;

FIG. 15 is a schematic diagram for explaining an example of vibrating an image in a display screen as an example of reporting a result obtained by determining whether a pointer is to be moved into a virtual screen;

FIG. 16 is a schematic diagram for explaining an example of outputting sound as an example of reporting a result obtained by determining whether a pointer is to be moved into a virtual screen;

FIG. 17 is a schematic diagram for explaining an example of vibrating an input device as an example of reporting a result obtained by determining whether a pointer is to be moved into a virtual screen;

FIG. 18 is a schematic diagram for explaining an example of a deviation between a position indicated by the input device and a position of the pointer;

FIG. 19 is a schematic diagram for explaining an example of a deviation between a position indicated by the input device and a position of the pointer;

FIG. 20 is a schematic diagram for explaining a procedure of a bordering correction;

FIG. 21 is a schematic diagram for explaining a procedure of the bordering correction;

FIG. 22 is a schematic diagram for explaining an exemplary process performed by the information processing device capable of setting a virtual screen; and

FIG. 23 is a schematic diagram for explaining a procedure of the bordering correction using a virtual screen.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order:

1. Discussion of Related Art

2. General Configuration of Information Processing System

3. Configuration of Input Device

4. Configuration of Information Processing Device

5. Procedure of Processing by Information Processing System

### 1. Discussion of Related Art

An information processing system according to an embodiment of the present disclosure is provided through the discussion of related art. The related art of an embodiment of the present disclosure will be described first.

In recent years, an information processing system capable of remotely operating a pointer displayed on a display screen has been developed. Such an information processing system includes an information processing device for displaying the pointer on the display screen and an input device for remotely operating the pointer. As an example of such an input device, a motion sensor remote controller is employed. As an example of the motion sensor remote controller, two types of remote controllers are employed. One is capable of detecting absolutely the orientation of a remote controller, and the other estimates the orientation of a remote controller based on a value detected by an acceleration sensor, a gyro sensor, or the like (namely, the orientation of a remote controller is relatively detected).

As used herein, the orientation of a remote controller refers to, for example, the orientation of a directional vector that is set previously in the remote controller. The directional vector is a vector that is set previously in a gyro controller and often extends along the longitudinal direction of the gyro controller. The remote controller of the latter (hereinafter also referred to as “gyro controller”) detects the direction and amount of movement of a directional vector based on a value detected by an acceleration sensor, a gyro sensor, or the like and transmits operation information about the detected direction and amount of movement to an information processing device. The information processing device moves a pointer in a display screen based on the operation information. In this way, the information processing device moves a pointer based on the relative orientation of the gyro controller (namely, the direction and amount of movement of the gyro controller) rather than the absolute orientation.

In this way, the information processing device moves a pointer based on the direction and amount of movement of the gyro controller, and thus the position of a pointer and the position indicated by the gyro controller (an intersection between a plane including a display screen and a directional vector) do not necessarily agree with each other. In addition, even when thus the position of a pointer and the position indicated by the gyro controller agree with each other, there may be a deviation in position between both of them with movement of the gyro controller. Such a deviation in position may occur due to insufficient accuracy of the gyro controller or the like, delayed processing of operation information in the gyro controller or the information processing device, or erroneous determination of operation information as noise by the information processing device. The deviation in position caused by movement of the gyro controller is referred to as “drift” hereinafter. The drift tends to increase whenever the user moves the gyro controller.

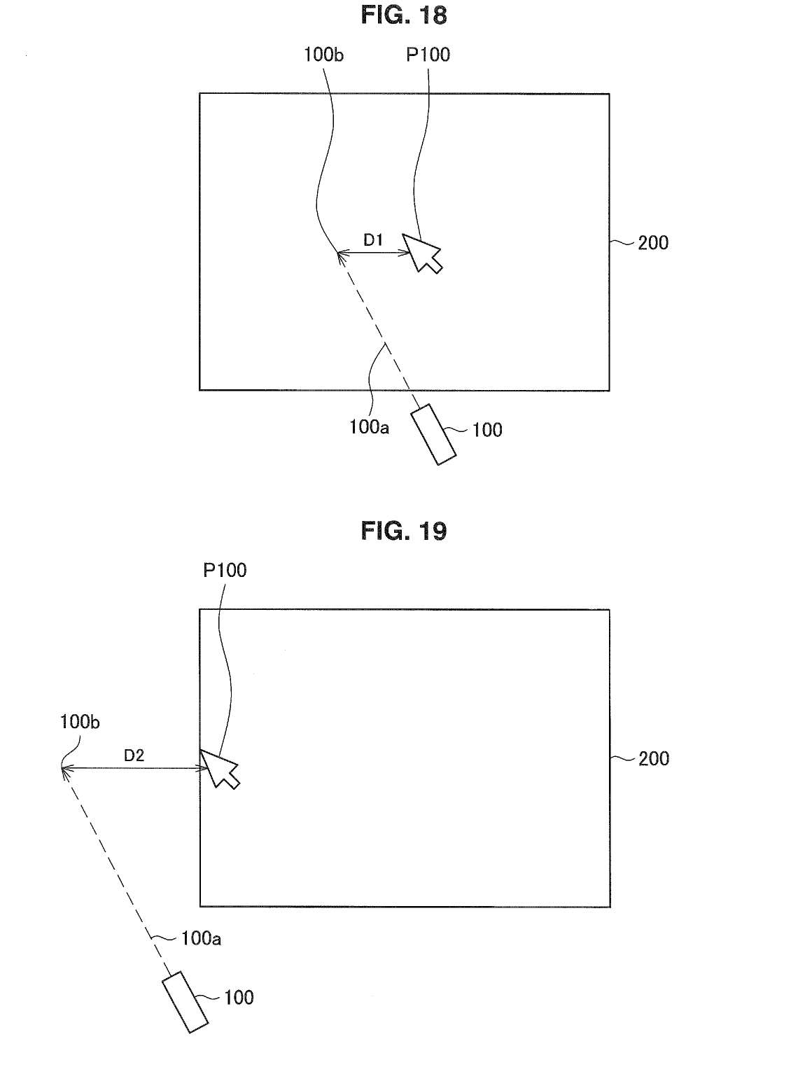

FIG. 18 illustrates an example of the drift. In this example, the user moves a gyro controller 100 to operate a pointer P100 displayed on a display screen 200. An information processing device displays the pointer P100 as an arrow image. A directional vector 100a is set in the gyro controller 100, and an intersection between the directional vector 100a and a plane including the display screen 200 is an indication position 100b indicated by the gyro controller. A drift D1 occurs between the indication position 100b and the position of the pointer P100.

In some cases, the user directs a directional vector of a gyro controller out of a display screen. In this case, an information processing device can move the pointer only to the edge of the display screen. Thus, even in this case, there occurs a deviation in position between the position indicate by the gyro controller and the position of the pointer. This deviation is also referred to as “warping” hereinafter.

FIG. 19 illustrates an example of the warping. In this example, the user directs a directional vector 100a of the gyro controller 100 out of the display screen 200. However, the information processing device can only move the pointer P100 to the edge of the display screen 200. Thus, a warping D2 occurs.

As a method of correcting the deviation in position between the indication position and the pointer position, the bordering correction is employed. How the bordering correction works will be described with reference to FIGS. 20 to 23. The description will be given on the assumption that the warping D2 of FIG. 19 is to be corrected.

As shown in FIG. 20, the user turns the gyro controller 100 in a clockwise direction. Accordingly, the information processing device moves the pointer P100 to the right. The user turns the gyro controller 100 in a clockwise direction until the pointer P100 reaches the right edge of the display screen 200. At the time when the warping occurs, the indication position 100b is placed on the left side beyond the position of the pointer P100, and thus the pointer P100 reaches the right edge of the display screen 200 before the indication position 100b reaches the right edge of the display screen 200.

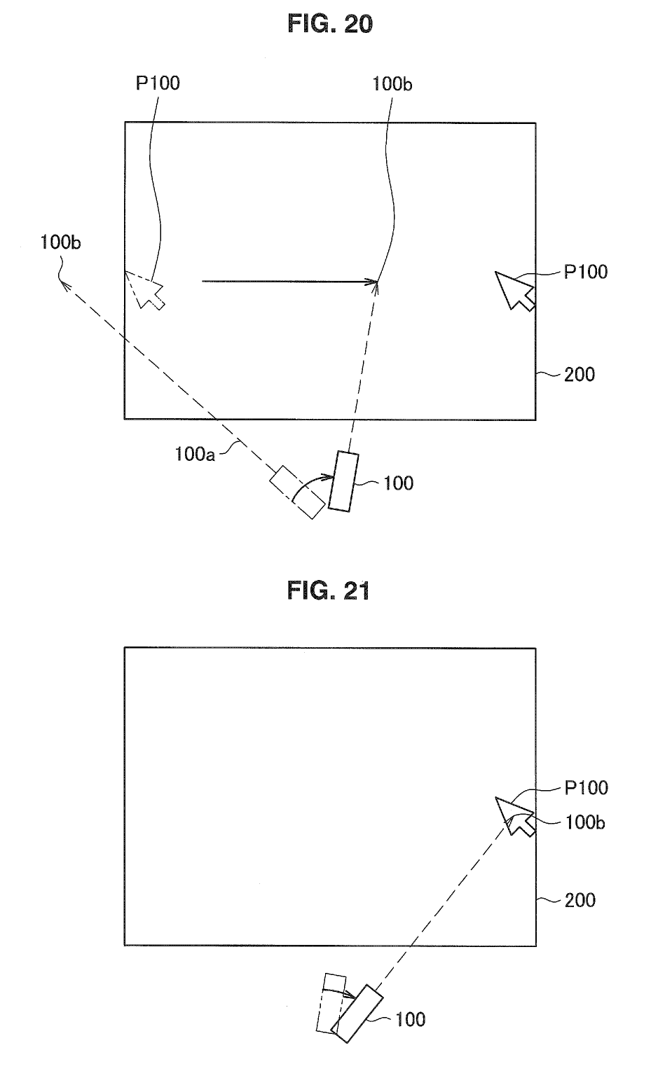

The user then further turns the gyro controller 100 in a clockwise direction so that the indication position 100b agrees with the position of the pointer P100 as shown in FIG. 21. At this time, the pointer P100 is placed on the right edge of the display screen 200, and thus even when the user turns the gyro controller 100 in a clockwise direction, the pointer P100 remains in its own position. As a result, the user can match the indication position 100b with the position of the pointer P100.

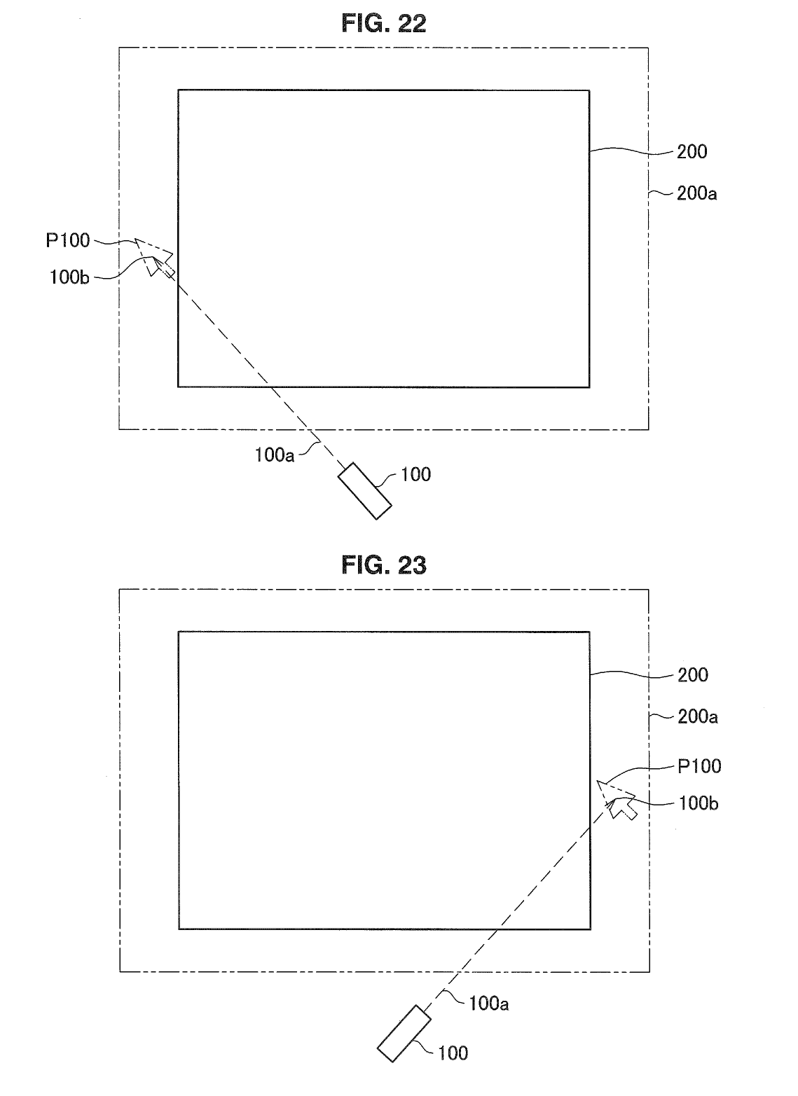

On the other hand, a technique for setting a virtual screen around a display screen is also disclosed in WO 09/72504. In this technique, the information processing device sets the virtual screen around the display screen. The information processing device then moves a pointer within the display screen and the virtual screen. This technique reduces occurrence of the warping. The reason why this is so will be described with reference to FIG. 22.

In the example shown in FIG. 22, the information processing device sets a virtual screen 200a around the display screen 200. When the user moves the gyro controller 100, the information processing device moves the pointer P100 based on the direction and amount of movement of the directional vector 100a. In this case, the information processing device moves the pointer P100 within the display screen and the virtual screen. Thus, when an indication position 100b is out of the display screen 200, the information processing device can move the pointer P100 into the virtual screen so that the position of the pointer P100 matches with the indication position 100b. Thus, the information processing device can reduce occurrence of the warping.

However, when the information processing device sets the virtual screen around the display screen, the drift will still occur. In addition, the information processing device is unable to move the pointer out of the virtual screen, and thus the warping occurs when the user directs a directional vector out of the virtual screen. It is considered that the above-described bordering correction may be performed as a way to correct the drift or warping.

In other words, as shown in FIG. 23, the information processing device is unable to move the pointer P100 out of the virtual screen 200a. Thus, it is theoretically possible for the user to move the pointer P100 to the edge of the virtual screen 200a and then match the indication position 100b with the position of the pointer P100 in a manner similar to the case shown in FIG. 21.

However, the virtual screen is an area set within the information processing device and is not intended to be displayed actually. Accordingly, it is difficult for the user to find out where the edge of the virtual screen is and thus, in practice, it is not easy for the user to perform the above-described bordering correction. In this way, when the information processing device sets the virtual screen around the display screen, the user will have difficulty in performing the bordering correction. As a result, in some cases, the user may not want to move the pointer into the virtual screen even if the user wants to perform the bordering correction. Nevertheless, in the technique disclosed in WO 09/72504, the pointer is moved into the virtual screen regardless of the user's desire. Thus, the user may feel uncomfortable with the input operation.

A technique that uses a correcting button is employed as a way to correct the deviation between the indication position and the position of the pointer. In this technique, the gyro controller is provided with the correcting button. When the user presses the correcting button, the information processing device forces the pointer to be moved to a given position in the display screen (for example, the center of the display screen). Thus, the user can match the position indicated by the gyro controller with the given position and then press the correcting button to correct the deviation between the position indicated by the gyro controller and the given position. However, this technique is necessary to provide the correcting button for the gyro controller, which takes much time and labor in manufacturing the gyro controller. In addition, the user will waste time and labor in matching the indication position with the given position.

The information processing system according to an embodiment of the present disclosure determines whether a pointer is to be moved into a virtual screen based on the state of the pointer when the pointer is moved to the edge of a display screen. For example, when it is estimated that the user wants to perform the bordering correction, the information processing system keeps the pointer within the display screen. This makes it possible for the user to perform the bordering correction and perform an operation of a pointer using the virtual screen, thereby reducing an uncomfortable feeling given to the user who performs an input operation. An embodiment of the present disclosure will be described in detail.

### 2. General Configuration of Information Processing System

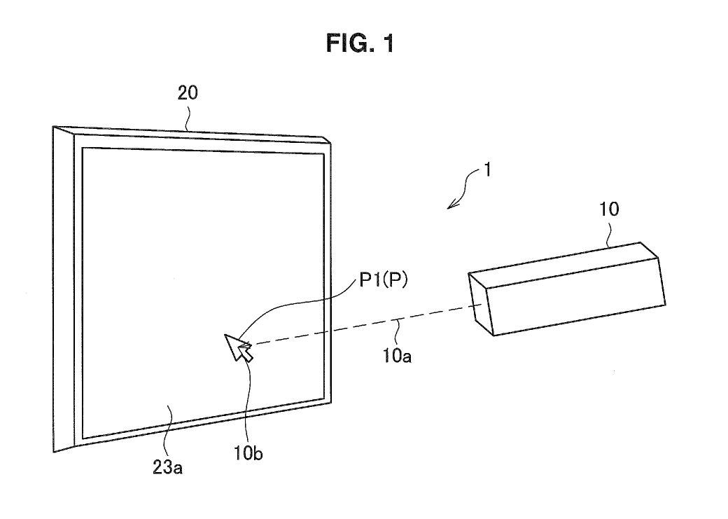

A general configuration of the information processing system 1 according to an embodiment of the present disclosure will be described with reference to FIG. 1. The information processing system 1 is configured to include an input device 10 and an information processing device 20. The information processing device 20 includes a display screen 23a and displays various types of images on the display screen 23a. In addition, the information processing device 20 displays a pointer P on a display screen 23a to fit the pointer P within the display screen 23a and moves the pointer P based on operation information from the input device 10.

In an embodiment of the present disclosure, the pointer P is two-dimensional coordinate information. In other words, the pointer P is a coordinate point on the x-y plane that contains the display screen 23a. The x-y plane is a plane that contains a virtual screen 23b described later in addition to the display screen 23a. The pointer P is displayed on the display screen 23a as a pointer image P1 while the pointer P is moved within the display screen 23a. The pointer P1 is represented, for example, as an image of a turbid (that is, not clear) or white arrow.

The input device 10 may be a gyro controller. In other words, a directional vector 10a is set in the input device 10. The directional vector 10a may be a vector that is parallel to the longitudinal direction of the input device 10. The directional vector 10a may also be a vector that extends in other directions. In addition, the intersection between the directional vector 10a and the plane that contains the display screen 23a is an indication position 10b. Thus, even in an embodiment of the present disclosure, a deviation may occur between the indication position and the position of the pointer. However, according to an embodiment of the present disclosure, the user can match the indication position 10b with the position of the pointer using the bordering correction while using the virtual screen.

In this way, an embodiment of the present disclosure is suitably applicable to an input device, for example, a gyro controller that has directivity and ability to remotely operate a pointer, but an embodiment of the present disclosure may be applicable an input device other than the input device 10. In other words, the input device 10 may be any input device that can perform an input operation to move a pointer and is not limited to a particular device. For example, the input device 10 includes a mouse, keyboard, trackball, or other input devices.

### 3. Configuration of Input Device

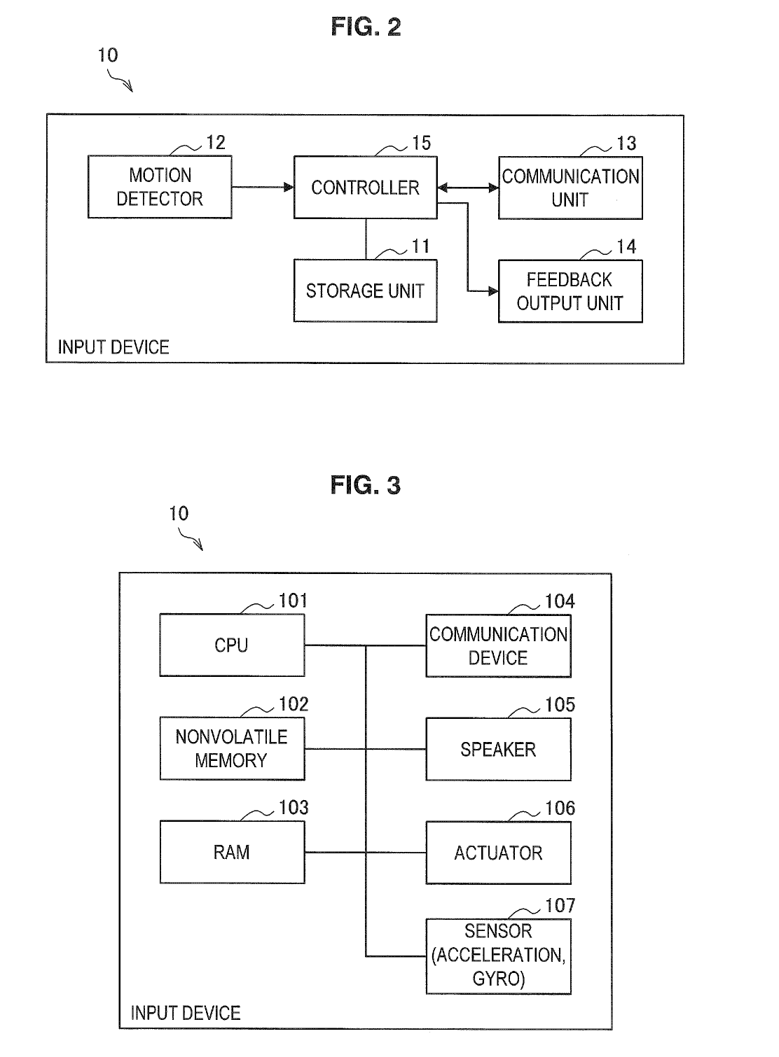

The configuration of the input device 10 will be described with reference to FIGS. 2 and 3. The input device 10 is configured to include a storage unit 11, a motion detector 12, a communication unit 13, a feedback output unit 14, and a controller 15, as shown in FIG. 2.

The storage unit 11 stores a program that used to allow the input device 10 to implement the storage unit 11, the motion detector 12, the communication unit 13, the feedback output unit 14, and the controller 15 and stores various image information.

The motion detector 12 detects motion information, such as acceleration or angular velocity of the directional vector 10a, that is necessary to detect the amount and direction of movement of the directional vector 10a and outputs the detected information to the controller 15. The communication unit 13 communicates with the information processing device 20 and outputs information obtained by the communication to the controller 15.

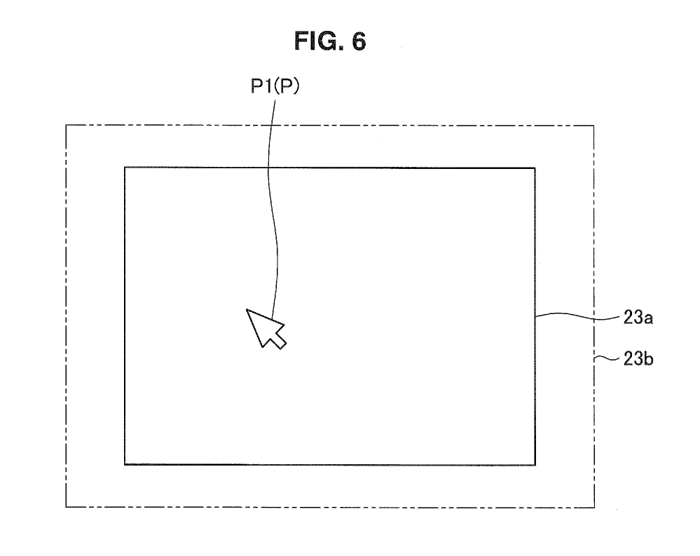

The feedback output unit 14 reports (that is, feeds back) a result obtained by determining whether the pointer P is moved into the virtual screen 23b (see FIG. 6). For example, the feedback output unit 14 vibrates when the pointer P hits the edge of the display screen 23a (that is, the pointer does not enter into the virtual screen 23b yet). A way of providing feedback is not limited thereto, and its more detailed description will be given later.

The controller 15 controls the entire input device 10 and performs processing such as detecting the amount and direction of movement of the directional vector 10a, for example, based on motion information. The controller 15 outputs operation information about the amount and direction of movement of the directional vector 10a to the communication unit 13. The communication unit 13 outputs the operation information to the information processing device 20.

The input device 10 has a hardware configuration shown in FIG. 3. This hardware configuration allows the storage unit 11, the motion detector 12, the communication unit 13, the feedback output unit 14, and the controller 15 to be implemented.

Specifically, the input device 10 is configured to include, as a hardware configuration, a CPU 101, a nonvolatile memory 102, a RAM 103, communication device 104, a speaker 105, an actuator 106, and a sensor 107. The sensor 107 may be implemented as various types of sensors. The CPU 101 reads out and executes a program stored in the nonvolatile memory 102. The program includes a program that used to allow the input device 10 to implement the storage unit 11, the motion detector 12, the communication unit 13, the feedback output unit 14, and the controller 15. Thus, the CPU 101 reads out and executes the program stored in the nonvolatile memory 102, which allows the storage unit 11, the motion detector 12, the communication unit 13, the feedback output unit 14, and the controller 15 to be implemented. In other words, the CPU 101 can be a substantial main component for execution in the input device 10.

The RAM 103 is an area in which the CPU 101 works. The communication device 104 communicates with the information processing device 20. The speaker 105 outputs a variety of sounds. The actuator 106 vibrates the input device 10. The sensor 107 includes an acceleration sensor, a gyro sensor, or the like. The sensor 107 detects motion information, such as acceleration or angular velocity of the directional vector 10a, that is necessary to detect the amount and direction of movement of the directional vector 10a.

### 4. Configuration of Information Processing Device

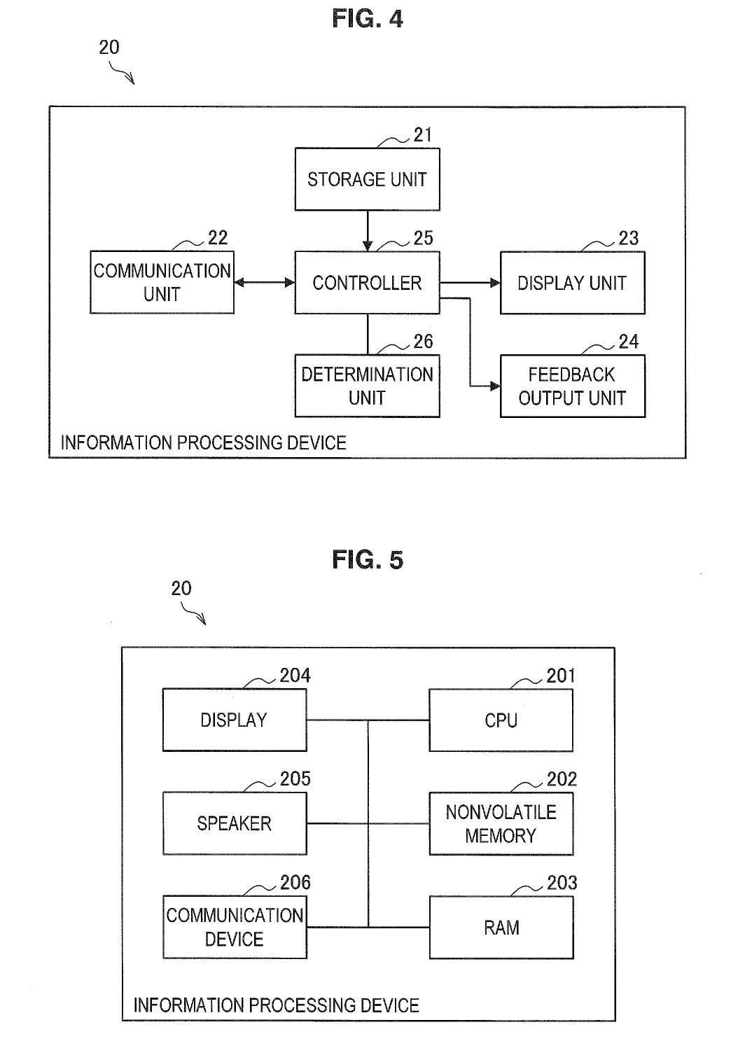

The configuration of the information processing device 20 will be described with reference to FIGS. 4 to 6. The information processing device 20 is configured to include a storage unit 21, a communication unit 22, a display unit 23, a feedback output unit 24, a controller 25, and a determination unit 26, as shown in FIG. 4.

The storage unit 21 stores a program that used to allow the information processing device 20 to implement the storage unit 21, the communication unit 22, the display unit 23, the feedback output unit 24, the controller 25, and the determination unit 26 and stores various image information.

The communication unit 22 communicates with the input device 10 and outputs information obtained by the communication to the controller 25. For example, the communication unit 22 outputs operation information transmitted from the input device 10 to the controller 25.

The display unit 23 has a display screen 23a as shown in FIG. 6 and displays various images on the display screen 23a under the control of the controller 25. For example, the display unit 23 displays a pointer P on the display screen 23a.

The feedback output unit 24 reports (that is, feeds back) a result obtained by determining whether the pointer P is moved into a virtual screen 23ba. For example, the feedback output unit 24 vibrates an image in the display screen 23a when the pointer P hits the edge of the display screen 23a (that is, the pointer does not enter the virtual screen). This makes it possible for the feedback output unit 24 to indicate a fact that the pointer P hits the edge of the display screen 23a. A way of providing feedback is not limited thereto, and its more detailed description will be given later.

The controller 25 controls the entire information processing device 20 and also performs the following processing. In other words, the controller 25 sets a virtual screen 23b around the display screen 23a as shown in FIG. 6. The size of the virtual screen 23b may not matter. As the size of the virtual screen 23b becomes larger, the warping becomes less likely to occur.

Furthermore, the controller 25 determines the position of the pointer P based on the operation information. The controller 25 moves the pointer P to the determined position in the display screen 23a or the virtual screen 23b.

In this regard, if the determined position is a position in the virtual screen 23b, then the controller 25 moves the pointer P to the edge portion of the display screen 23a. The controller 25 then causes the determination unit 26 to determine whether the pointer P is to be moved into the virtual screen 23b. If it is determined that the pointer P is to be moved into the virtual screen 23b, then the controller 25 moves the pointer P into the virtual screen 23b. On the other hand, if it is determined that the pointer P is to be kept within the display screen 23a, the controller 26 keeps the pointer P within its current position (at the edge of the display screen 23a).

The determination unit 26 determines whether the pointer P is to be moved into the virtual screen 23b based on the state of the pointer. Its more detailed processing will be described later.

The information processing device 20 has a hardware configuration shown in FIG. 5. This hardware configuration allows the storage unit 21, the communication unit 22, the display unit 23, the feedback output unit 24, the controller 25, and the determination unit 26 to be implemented.

Specifically, the information processing device 20 is configured to include, as a hardware configuration, a CPU 201, a nonvolatile memory 202, a RAM 203, a display 204, a speaker 205, and a communication device 204. The CPU 201 reads out and executes a program stored in the nonvolatile memory 202. The program includes a program that used to allow the information processing device 20 to implement the storage unit 21, the communication unit 22, the display unit 23, the feedback output unit 24, the controller 25, and the determination unit 26. Thus, the CPU 201 reads out and executes the program stored in the nonvolatile memory 202, which allows the storage unit 21, the communication unit 22, the display unit 23, the feedback output unit 24, the controller 25, and the determination unit 26 to be implemented. In other words, the CPU 201 can be a substantial main component for execution in the information processing device 20.

The RAM 203 is an area in which the CPU 201 works. The display 204 displays various images and the pointer P on the display screen 23a. The speaker 205 outputs a variety of sounds. The communication device 206 communicates with the input device 10.

### 5. Procedure of Processing by Information Processing System

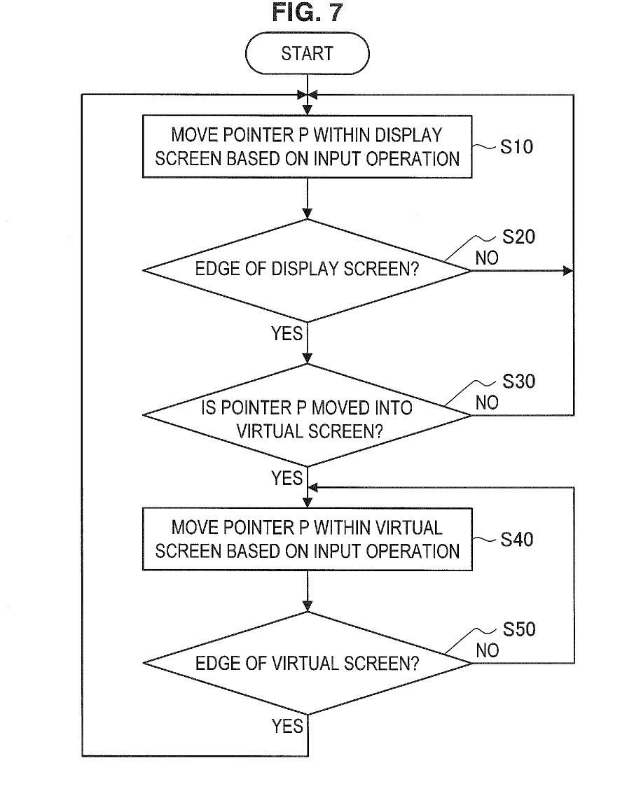

The procedure of processing performed by the information processing system 1 will be described with reference to the flowchart shown in FIG. 7. The processing is based on the assumption that the controller 25 sets the virtual screen 23b around the display screen 23a and displays the pointer P on the display screen 23a.

In step S10, the user moves the input device 10 in a desired direction. In other words, the user performs an input operation using the input device 10. In response, the motion detector 12 of the input device 10 detects motion information such as acceleration and angular velocity and outputs the detected information to the controller 15. The controller 15 detects the amount and direction of movement of the directional vector 10a based on the motion information. Then, the controller 15 generates operation information about the amount and direction of movement of the directional vector 10a and outputs the generated information to the communication unit 13. The communication unit 13 transmits the operation information to the information processing device 20.

The communication unit 22 of the information processing device 20 receives the operation information and outputs the operation information to the controller 25. The controller 25 moves the pointer P based on the operation information. More specifically, the controller 25 determines a movement trajectory of the pointer P based on the operation information and moves the pointer P along the determined movement trajectory. If the movement trajectory appears on the virtual screen 23b, the controller 25 moves the pointer P to the edge of the display screen 23a. More specifically, the controller 25 moves the pointer P to the intersection between the movement trajectory and the edge line of the display screen 23a.

In step S20, the controller 25 determines whether a current position of the pointer P is at the edge of the display screen 23a. If it is determined that the current position of the pointer P is at the edge of the display screen 23a, then the process proceeds to step S30 by the controller 25. If it is determined that the current position of the pointer P is at a position other than the edge of the display screen 23a, then the process returns to step S10 by the controller 25.

In step S30, the controller 25 causes the determination unit 26 to determine whether the pointer P is to be moved into the virtual screen 23b.

The determination unit 26 determines whether the pointer P is to be moved into the virtual screen 23b based on the state of the pointer P. More specifically, the determination unit 26 determines whether the pointer P is to be moved into the virtual screen 23b based on at least one of the position and moving state of the pointer P.

More specifically, the determination unit 26 determines whether the condition for keeping the pointer P within the display screen 23a is satisfied. If it is determined that the condition is satisfied, then the determination unit 26 determines that the pointer P is to be kept within the display screen 23a. If it is determined that the condition is not satisfied, then the determination unit 26 determines that the pointer P is to be moved into the virtual screen 23b. In this regard, an example of the condition includes the first to seventh conditions described below.

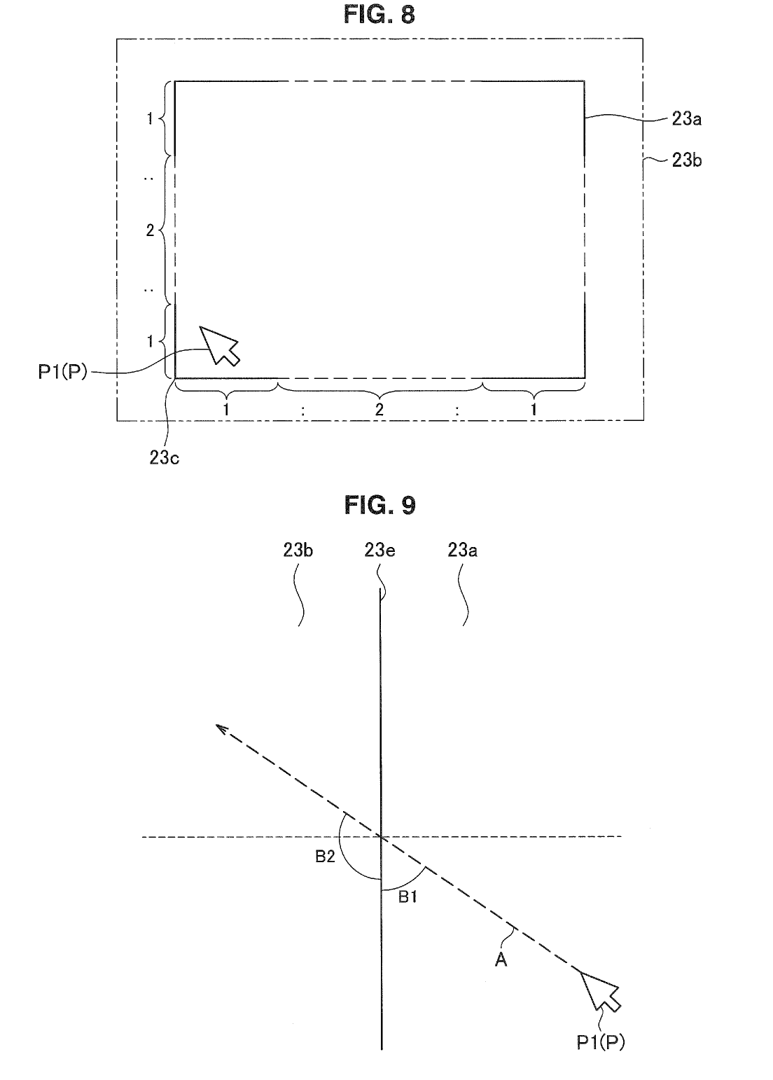

The first condition is a condition that the pointer P is located at the corner. The corner may be an end portion that is within a predetermined range from the top of the display screen 23a. An example of the corner is illustrated in FIG. 8. In this example, a portion that is within the range of one-fourth of the long side and one-fourth of the short side from the top of the display screen 23a is a corner part 23c. The corner is not limited thereto. The predetermined range is determined, for example, in consideration of the balance between the position from the display screen 23a to the input device 10 and the size of the display screen 23a.

The reason why the first condition is set as described above will be described. When the user performs the bordering correction, it is estimated that the pointer P is more likely to hit the corner. Thus, when the pointer P is located at the corner, it is likely to be considered that the user wants to keep the pointer P within the display screen 23a. As a result, the first condition is set as described above. The determination unit 26 may set any of the corner parts of the display screen 23a as a corner part used to perform the bordering correction. In this case, when the pointer P is located at the corner part used to perform the bordering correction, the determination unit 26 may determine that the first condition is satisfied.

The second condition is a condition in which an angle of entrance of the pointer P is greater than or equal to a predetermined value. The angle of entrance is an angle B1 formed by a velocity vector A of the pointer P and the edge line 23e of the display screen 23a as shown in FIG. 9. An angle B2 may be also assumed as an angle formed by them, however in an embodiment of the present disclosure, the smaller one of the angles B1 and B2 is employed. When the two angles are equal (B1 and B2 have an angle of 90 degrees), the angle of entrance is 90 degrees. The predetermined value may be 90 degrees or a value close to 90 degrees, for example, 70 degrees or greater. The predetermined value is determined, for example, in consideration of the balance between the position from the display screen 23a to the input device 10 and the size of the display screen 23a.

The reason why the second condition is set as described above will be described. When the user performs the bordering correction, it is estimated that the pointer P is more likely to hit the edge portion of the display screen 23a at an angle perpendicular, or nearly perpendicular, to the edge portion of the display screen 23a. Thus, when the angle of entrance of the pointer P has a vertical or nearly vertical angle (i.e., an angle greater than or equal to the predetermined value described above), it is likely to be considered that the user wants to keep the pointer P within the display screen 23a. As a result, the second condition is set as described above.

The third condition is a condition in which entry velocity of the pointer P (the moving velocity to the edge of the display screen) is greater than or equal to a predetermined value. The entry velocity is a component of the velocity vector A of the pointer P in the direction perpendicular to the edge line of the display screen 23a. In addition, in the entry velocity, a direction toward the virtual screen 23b from the display screen 23a is set as the forward direction. The entry velocity may be all components of the velocity vector A of the pointer P. The predetermined value is determined, for example, in consideration of the balance between the position from the display screen 23a to the input device 10 and the size of the display screen 23a. For example, the predetermined value is 300 millimeters per second (mm/s) for a 40-inch display. The predetermined value becomes larger as the size of the display screen 23a becomes larger.

The reason why the third condition is set as described above will be described. When the user performs the bordering correction, it is estimated that the pointer P is more likely to swiftly hit the edge portion of the display screen 23a. Thus, when the entry velocity of the pointer P is large (i.e., when it is greater than or equal to the predetermined value described above), it is likely to be considered that the user wants to keep the pointer P within the display screen 23a. As a result, the third condition is set as described above.

The fourth condition is a condition in which entry acceleration of the pointer P is greater than or equal to zero. The entry acceleration is a component of the acceleration (acceleration of the velocity vector A) of the pointer P in the direction perpendicular to the edge line of the display screen 23a. In the entry acceleration, a direction toward the virtual screen 23b from the display screen 23a is set as the forward direction.

The reason why the fourth condition is set as described above will be described. When the user performs the bordering correction, it is estimated that the pointer P is more likely to hit the edge portion of the display screen 23a with an acceleration of velocity. Thus, when the entry acceleration of the pointer P is greater than or equal to zero, it is likely to be considered that the user wants to keep the pointer P within the display screen 23a. As a result, the fourth condition is set as described above.

The fifth condition is a condition in which a distance over which the pointer P is moved in a straight line until the pointer P reaches the edge of the display screen 23a is greater than or equal to a predetermined value. The distance over which the pointer is moved in a straight line is represented, for example, by a distance d1 in FIG. 10. A method of measuring the distance over which the pointer is moved in a straight line is not particularly limited, and the following methods may be given as examples.

Specifically, the determination unit 26 sets an x-coordinate value integration counter that integrates an x-coordinate value of the pointer P and a y-coordinate value integration counter that integrates a y-coordinate value of the pointer P in the storage unit 21. When the pointer P is moved along a movement trajectory other than a straight line (for example, an arc, a polygonal line, etc.) or the movement trajectory is turned around by 180 degrees (moved in a direction opposite to the previous moving direction), the determination unit 26 resets these counter values. Thus, these counter values indicate the distance over which the pointer P is moved in a straight line until the pointer P reaches the edge of the display screen 23a. The determination unit 26 calculates the distance over which the pointer P is moved in a straight line until the pointer P reaches the edge of the display screen 23a based on these counter values.

Furthermore, the predetermined value is determined, for example, in consideration of the balance between the position from the display screen 23a to the input device 10 and the size of the display screen 23a. For example, the predetermined value is 300 millimeters (mm) for a 40-inch display. The predetermined value becomes larger as the size of the display screen 23a becomes larger.

The reason why the fifth condition is set as described above will be described. When the user performs the bordering correction, it is estimated that the pointer P is more likely to be moved straight toward the edge from a position distant from the edge of the display screen 23a. Thus, when the entry acceleration of the pointer P is greater than or equal to zero, it is likely to be considered that the user wants to keep the pointer P within the display screen 23a. As a result, the fifth condition is set as described above.

The sixth condition is a condition in which a distance from an object in the display screen 23a to the pointer P is greater than or equal to a predetermined value. The distance from an object in the display screen 23a to the pointer P may be a distance from a tip of the pointer image P1 (an arrow image) to a reference point that is set in the object. An example of the distance from an object in the display screen 23a to the pointer P is illustrated in FIG. 11. A distance d2 shown in FIG. 11 indicates the distance between an object 23d and the pointer P. When a plurality of objects are displayed in the display screen 23a, the distance from an object nearest the pointer P to the pointer P may be employed. The predetermined value is determined, for example, in consideration of the balance between the position from the display screen 23a to the input device 10 and the size of the display screen 23a. For example, the predetermined value is 50.0 to 100.0 millimeters (mm) for a 40-inch display. The predetermined value becomes larger as the size of the display screen 23a becomes larger.

The reason why the sixth condition is set as described above will be described. When the user works using an object, it is estimated that the pointer P is more likely to be placed near the object. On the other hand, when the user performs the bordering correction, it is considered that the pointer P is more likely to be placed in a position distant from the object. Thus, when the pointer P is distant from an object (namely, the distance between them is greater than or equal to a predetermined value), it is likely to be considered that the user wants to keep the pointer P within the display screen 23a. As a result, the sixth condition is set as described above.

The seventh condition is a condition in which a period of time measured from the most recent point of time to a current point of time from among the points of time at which the pointer P passes through an object in the display screen 23a is greater than or equal to a predetermined value. The predetermined value is determined, for example, in consideration of the balance between the position from the display screen 23a to the input device 10 and the size of the display screen 23a. For example, the predetermined value is 100 milliseconds (ms) for a 40-inch display. The predetermined value becomes larger as the size of the display screen 23a becomes larger.

The reason why the seventh condition is set as described above will be described. When the user works using an object, it is estimated that the pointer P is more likely to be superimposed on the object frequently. On the other hand, when the user performs the bordering correction, it is estimated that the pointer P is more likely to hit the edge of the display screen 23a without being superimposed on the object. Thus, when a long period of time (namely, a period of time greater than or equal to a predetermined value) has passed since the pointer P passes through an object in the display screen 23a, it is likely to be considered that the user wants to keep the pointer P within the display screen 23a. As a result, the seventh condition is set as described above.

The determination unit 26 determines the first to seventh conditions in combination, and then, based on the result of determination, the determination unit 26 determines whether the pointer P is to be moved into the virtual screen 23b. For example, the determination unit 26 may give a priority to the first to seventh conditions. In this case, determination of the conditions by the determination unit 26 is performed in order of decreasing priority, and if it is determined that any one condition is satisfied, it can be determined that the pointer P is to be kept within the display screen 23a. For example, the determination unit 26 may set the first condition to have the highest priority. This is because it is estimated that the user is likely to perform the bordering correction using the corner part of the display screen 23a. In addition, the third to fifth conditions may be set to have a higher priority than other conditions. This is because, when the user performs the bordering correction, it is estimated that the pointer P is more likely to be swiftly moved straight toward the edge of the display screen 23a from a position distant from the edge of the display screen 23a.

Moreover, if a predetermined number or more of conditions are satisfied from among the first to seventh conditions, the determination unit 26 may determine that the pointer P is to be kept within the display screen 23a. In addition, if conditions having a high relevance to each other from among the first to seventh conditions are grouped and conditions in the group are all satisfied, the determination unit 26 may determine that the pointer P is to be kept within the display screen 23a.

For example, as described above, when the user performs the bordering correction, it is estimated that the pointer P is more likely to be swiftly moved straight toward the edge of the display screen 23a from a position distant from the edge of the display screen 23a. Thus, if the third to fifth conditions are grouped and are all satisfied, the determination unit 26 may determine that the pointer P is to be kept within the display screen 23a.

If at least one condition is satisfied from among the first to seventh conditions, the determination unit 26 may determine that the pointer P is to be kept within the display screen 23a. As described above, the first to seventh conditions are intended to indicate whether the user wants to perform the bordering correction. Thus, the determination unit 26 can estimate whether the user wants to perform the bordering correction by determining whether the first to seventh conditions are satisfied.

The determination unit 26 outputs determination result information about the result obtained by the determination to the controller unit 25. Then, the controller 25 outputs the determination result information to the feedback output unit 24. The feedback output unit 24 feeds back the determination result to the user.

Specifically, the feedback output unit 24 displays the pointer P in different display modes depending on whether the pointer P is moved into the virtual screen 23b or is not moved into the virtual screen 23b. When the pointer P is moved into the virtual screen 23b, the pointer P does not exist on the display screen 23a. Thus, the feedback output unit 24 may not display a pointer image on the display screen 23a. When the pointer P is moved into the virtual screen 23b, the feedback output unit 24 displays a dummy image of the pointer P on the display screen 23a. The dummy image is displayed in a different way from the pointer image. The position at which the dummy image is displayed is not particularly limited. For example, the position at which the dummy image is displayed may be the intersection between a vertical line drawn to the edge line of the display screen 23a from the position of the pointer P and the edge line of the display screen 23a.

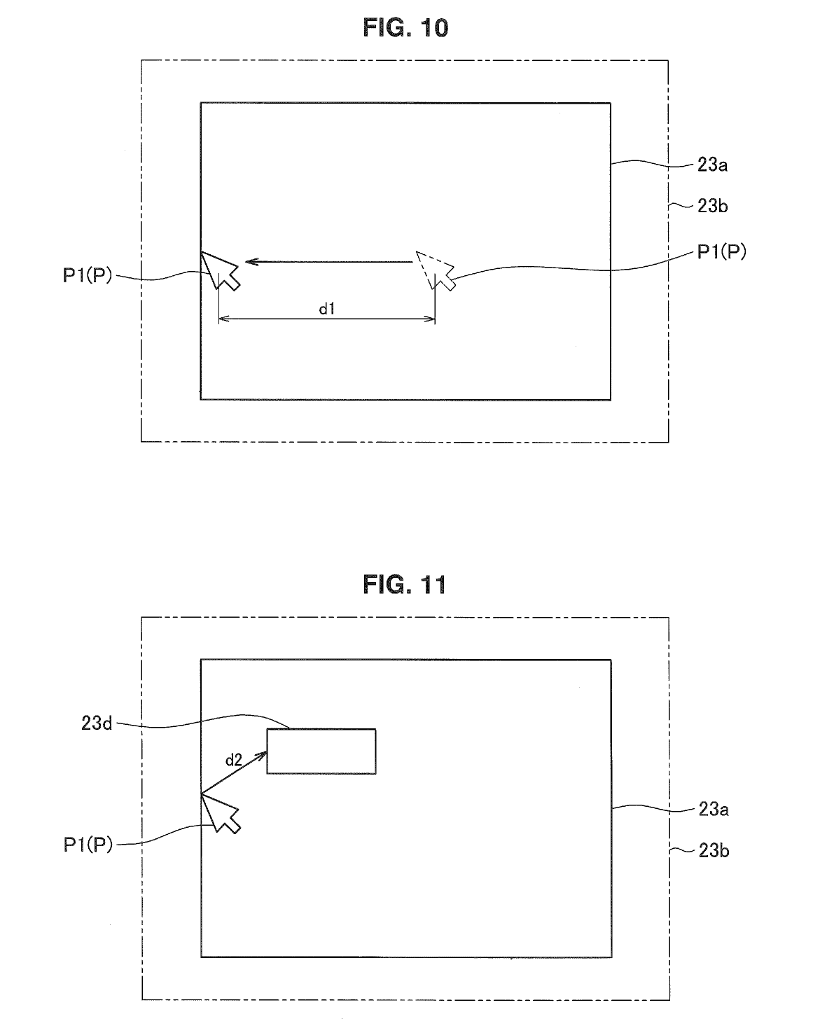

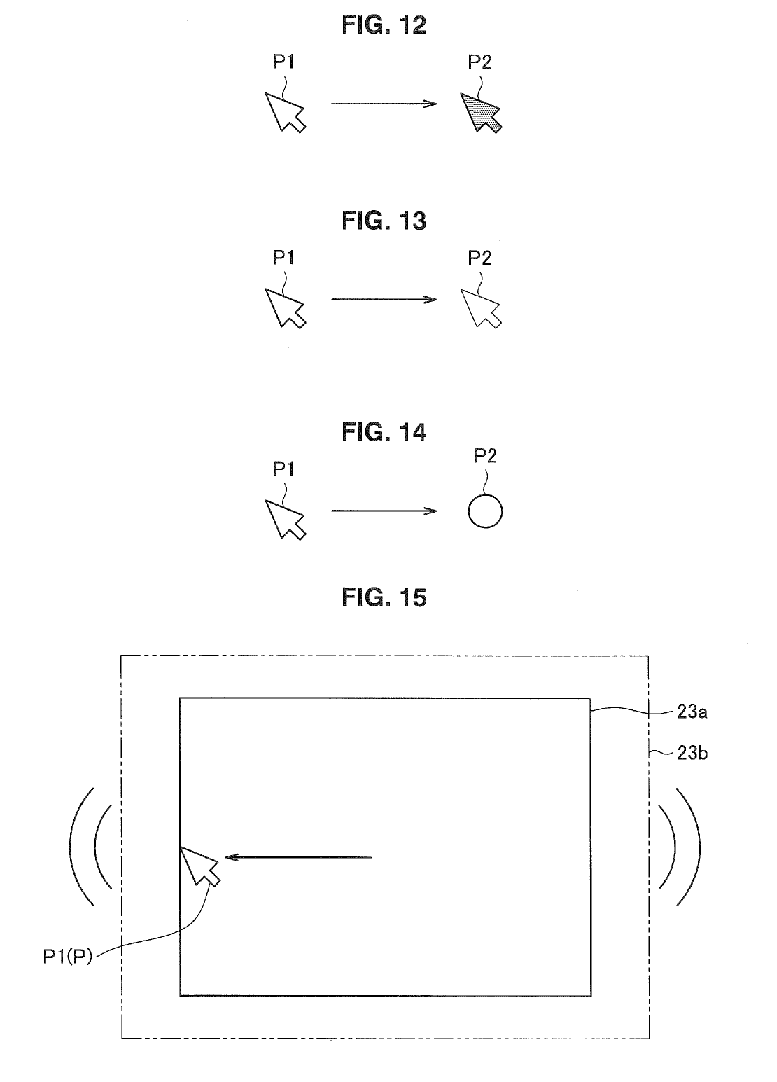

For example, when the pointer P remains within the display screen 23a, the feedback output unit 24 may keep the pointer image P1 at its default (for example, keeps the white color). In addition, when the pointer P is moved into the virtual screen 23b, the feedback output unit 24 may display the dummy image P2 in a color other than the default as shown in FIG. 12. In the example of FIG. 12, the dummy image is represented by hatching it with a color other than white.

The feedback output unit 24 can perform a process reverse to the process described above. In other words, when the pointer P remains within the display screen 23a, the feedback output unit 24 may display the pointer image P1 in a color other than the default. When the pointer P is moved into the virtual screen 23b, the feedback output unit 24 may display the dummy image P2 in the default color.

When the pointer P remains within the display screen 23a, the feedback output unit 24 may keep the transparency of the pointer image P1 at its default (for example, remains opaque). In addition, when the pointer P is moved into the virtual screen 23b, the feedback output unit 24 may display the dummy image P2 in a translucent manner as shown in FIG. 13. In the example of FIG. 13, difference in transparency is displayed in different types of lines.

The feedback output unit 24 can also perform a process reverse to the process described above. In other words, when the pointer P remains within the display screen 23a, the feedback output unit 24 displays the pointer image P1 in a translucent manner. When the pointer P is moved into the virtual screen 23b, the feedback output unit 24 may display the dummy image P2 in a default transparency (for example, an opaque white color).

When the pointer P remains within the display screen 23a, the feedback output unit 24 may keep the shape of the pointer image P1 at its default (for example, keeps its shape as an arrow image). In addition, when the pointer P is moved into the virtual screen 23b, the feedback output unit 24 may display the dummy image P2 in a round shape as shown in FIG. 13. The feedback output unit 24 can also display the dummy image P2 in a shape other than the round shape.

The feedback output unit 24 may also perform a process reverse to the process described above. In other words, when the pointer P remains within the display screen 23a, the feedback output unit 24 displays the pointer image P1 in a round shape. When the pointer P is moved into the virtual screen 23b, the feedback output unit 24 may display the dummy image P2 in a default shape (for example, an arrow). The feedback output unit 24 can also display the pointer image P1 in a shape other than the round shape.

Furthermore, when the pointer P remains at the edge of the display screen 23a (hits the edge) as shown in FIG. 15, the feedback output unit 24 may vibrate an image on the display screen 23a. This makes it possible for the feedback output unit 24 to represent that the pointer P hits the edge of the display screen 23a.

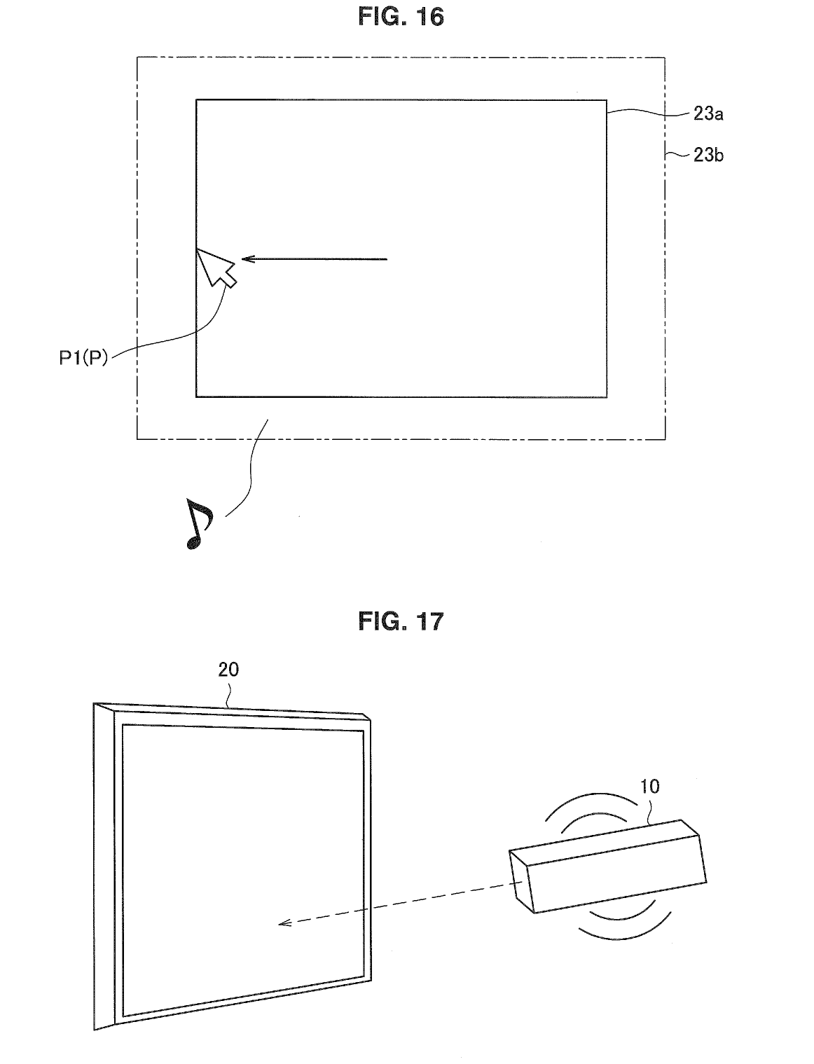

Moreover, the feedback output unit 24 may vibrate an image on the display screen 23a in a different way depending on whether the pointer P is moved into the virtual screen 23b or is not moved into the virtual screen 23b. In addition, when the pointer P is moved into the virtual screen 23b, the feedback output unit 24 may vibrate an image on the display screen 23a. Furthermore, the feedback output unit 24 may output sound instead of vibrating an image on the display screen 23a (or output sound accompanied by vibration) as shown in FIG. 16. In addition, it is also possible to vibrate the information processing device 20 itself.

Furthermore, the controller 25 may cause the input device 10 to perform feedback. In this case, the controller 25 outputs the determination result information to the communication unit 22. The communication unit 22 transmits the determination result information to the input device 10. The communication unit 13 of the input device 10 receives the determination result information and outputs it to the controller 15. The controller 15 outputs the determination result information to the feedback output unit 14.

The feedback output unit 14 vibrates when the pointer P remains within the display screen 23a (i.e., the pointer hits the edge of the display screen 23a). The feedback output unit 14 may vibrate in a different way depending on whether the pointer P is moved into the virtual screen 23b or the pointer P is not moved into the virtual screen 23b. In addition, the feedback output unit 14 may vibrate when the pointer P enters the virtual screen 23b. In addition, the feedback output unit 14 may output sound instead of vibration (or output sound accompanied by vibration).

The information processing system 1 may execute any one of the feedback types described above or may execute a plurality of types of feedback in parallel. In addition, a method of providing feedback is not limited to examples described above.

When it is determined that the pointer P is to be moved into the virtual screen 23b, the controller 25 moves the pointer P into the virtual screen 23b. Then, the process proceeds to step S40 by the controller 25. On the other hand, if it is determined that the pointer P remains within the display screen 23a, the process returns to step S10 by the controller 25.

In step S40, the user moves the input device 10 in a desired direction. In other words, the user performs an input operation using the input device 10. In response to this, the motion detector 12 of the input device 10 detects motion information such as acceleration and angular velocity and outputs the detected information to the controller 15. The controller 15 detects the amount and direction of movement of the directional vector 10a based on the motion information. Then, the controller 15 generates operation information about the amount and direction of movement of the directional vector 10a and outputs the generated information to the communication unit 13. The communication unit 13 transmits the operation information to the information processing device 20.

The communication unit 22 of the information processing device 20 receives the operation information and outputs the operation information to the controller 25. The controller 25 determines a movement trajectory of the pointer P based on the operation information. Then, the controller 25 moves the pointer P along the determined movement trajectory. In other words, the controller 25 moves the pointer P within the virtual screen 23b. In this regard, if the movement trajectory appears on the virtual screen 23b, the controller 25 moves the pointer P to the edge of the virtual screen 23b. More specifically, the controller 25 moves the pointer P to the intersection between the movement trajectory and the edge line of the virtual screen 23b.

In step S50, the controller 25 determines whether a current position of the pointer P is at the edge of the virtual screen 23b. If it is determined that the current position of the pointer P is at the edge of the virtual screen 23b, then the controller 25 moves the pointer P into the display screen 23a. Then, the process returns to step S10 by the controller 25. If it is determined that the current position of the pointer P is a position other than the edge of the virtual screen 23b, then the process returns to step S40 by the controller 25. If the user finishes the input operation, then the information processing system 1 ends the process.

As described above, when the user moves the pointer P to reach the edge of the display screen 23a without being intended to perform the bordering correction, the information processing system 1 according to an embodiment of the present disclosure can move the pointer P into the virtual screen 23b, thereby reducing occurrence of the warping. On the other hand, when the user moves the pointer P to reach the edge of the display screen 23a so that the user performs the bordering correction, the information processing system 1 can keep the pointer P within the display screen 23a. Thus, the user can perform the bordering correction, thereby performing correction of the warping or drift.

More specifically, when the pointer P is moved to the edge of the display screen 23a, the information processing system 1 determines whether the pointer P is to be moved into the virtual screen 23b, based on the state of the pointer P. Thus, the information processing system 1 can impose a limit on movement of the pointer P to the virtual screen 23b. As a result, the user who does not want to move the pointer P to the virtual screen 23b, for example, the user who wants to perform the bordering correction can keep the pointer P within the display screen 23a. Accordingly, the information processing system 1 can reduce the uncomfortable feeling of a user who performs an input operation.

In this regard, the information processing system 1 determines whether the pointer P is to be moved into the virtual screen 23b based on at least one of the position and moving state of the pointer P. Thus, the information processing system 1 can determine in more detail whether the pointer P is to be moved into the virtual screen 23b.

Moreover, the information processing system 1 determines whether the pointer P is moved to the corner part of the display screen 23a, and then, based on the result of determination, the information processing system 1 determines whether the pointer P is to be moved into the virtual screen 23b. Thus, the information processing system 1 can determine in more detail whether the pointer P is to be moved into the virtual screen 23b. Specifically, the information processing system 1 can estimate whether the user wants to perform the bordering correction, and then, based on the result of determination, can determine whether the pointer P is to be moved into the virtual screen 23b.

Furthermore, the information processing system 1 determines whether the pointer P is to be moved into the virtual screen based on the angle of entrance of the pointer P to the edge of the display screen 23a. Thus, the information processing system 1 can determine in more detail whether the pointer P is to be moved into the virtual screen 23b.

Moreover, the information processing system 1 determines whether the pointer P is to be moved into the virtual screen 23b based on the distance over which the pointer P is moved to the edge of the display screen 23a in a straight line. Thus, the information processing system 1 can determine in more detail whether the pointer P is to be moved into the virtual screen 23b.

Furthermore, the information processing system 1 determines whether the pointer P is to be moved into the virtual screen 23b based on the velocity at which the pointer P is moved to the edge of the display screen 23a (specifically, the entry velocity). Thus, the information processing system 1 can determine in more detail whether the pointer P is to be moved into the virtual screen 23b.

Moreover, the information processing system 1 determines whether the pointer P is to be moved into the virtual screen 23b based on the acceleration of the pointer P (specifically, the entry acceleration). Thus, the information processing system 1 can determine in more detail whether the pointer P is to be moved into the virtual screen 23b.

Furthermore, the information processing system 1 determines whether the pointer P is to be moved into the virtual screen 23b based on the distance from the pointer P to an object in the display screen 23a. Thus, the information processing system 1 can determine whether the pointer P is to be moved into the virtual screen 23b in more detail.

Moreover, the information processing system 1 can perform control for reporting the determination result, and thus the user can easily judge whether the pointer P is moved into the virtual screen 23b. The embodiments of the present disclosure may have any effect described herein and other effects not described herein.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below:
(1) An information processing device including:

a controller configured to move a pointer within a display screen based on operation information; and

a determination unit configured to determine whether the pointer is to be moved into a virtual screen set around the display screen, based on a state of the pointer when the pointer is moved to an edge of the display screen.

(2) The information processing device according to (1), wherein the determination unit determines whether the pointer is to be moved into the virtual screen, based on at least one of a position and a moving state of the pointer.
(3) The information processing device according to (2), wherein the determination unit determines whether the pointer is moved to a corner part of the display screen, and then, based on a result of the determination, determines whether the pointer is to be moved into the virtual screen.
(4) The information processing device according to (2) or (3), wherein the determination unit determines whether the pointer is to be moved into the virtual screen, based on an angle of entrance of the pointer to the edge of the display screen.
(5) The information processing device according to any one of (2) to (4), wherein the determination unit determines whether the pointer is to be moved into the virtual screen, based on a distance over which the pointer is moved to the edge of the display screen in a straight line.
(6) The information processing device according to any one of (2) to (5), wherein the determination unit determines whether the pointer is to be moved into the virtual screen, based on velocity at which the pointer is moved to the edge of the display screen.
(7) The information processing device according to any one of (2) to (6), wherein the determination unit determines whether the pointer is to be moved into the virtual screen, based on acceleration of the pointer.
(8) The information processing device according to any one of (2) to (7), wherein the determination unit determines whether the pointer is to be moved into the virtual screen, based on a distance from the pointer to an object in the display screen.
(9) The information processing device according to any one of (1) to (8), wherein the controller performs control for reporting a determination result obtained by the determination unit.
(10) An information processing method including:

moving a pointer within a display screen based on operation information; and

determining whether the pointer is to be moved into a virtual screen set around the display screen, based on a state of the pointer when the pointer is moved to an edge of the display screen.

(11) A program for causing a computer to execute:

a control function of moving a pointer within a display screen based on operation information; and

a determination function of determining whether the pointer is to be moved into a virtual screen set around the display screen, based on a state of the pointer when the pointer is moved to an edge of the display screen.

What is claimed is:

1. An information processing device comprising:
a controller configured to move a pointer within a display screen based on operation information; and
a determination unit configured to determine whether the pointer is to be moved into a virtual screen set around the display screen, based on a state of the pointer when the pointer is moved to an edge of the display screen.

2. The information processing device according to claim 1, wherein the determination unit determines whether the pointer is to be moved into the virtual screen, based on at least one of a position and a moving state of the pointer.

3. The information processing device according to claim 2, wherein the determination unit determines whether the pointer is moved to a corner part of the display screen, and then, based on a result of the determination, determines whether the pointer is to be moved into the virtual screen.

4. The information processing device according to claim 2, wherein the determination unit determines whether the pointer is to be moved into the virtual screen, based on an angle of entrance of the pointer to the edge of the display screen.

5. The information processing device according to claim 2, wherein the determination unit determines whether the pointer is to be moved into the virtual screen, based on a distance over which the pointer is moved to the edge of the display screen in a straight line.

6. The information processing device according to claim 2, wherein the determination unit determines whether the pointer is to be moved into the virtual screen, based on velocity at which the pointer is moved to the edge of the display screen.

7. The information processing device according to claim 2, wherein the determination unit determines whether the pointer is to be moved into the virtual screen, based on acceleration of the pointer.

8. The information processing device according to claim 2, wherein the determination unit determines whether the pointer is to be moved into the virtual screen, based on a distance from the pointer to an object in the display screen.

9. The information processing device according to claim 1, wherein the controller performs control for reporting a determination result obtained by the determination unit.

10. An information processing method comprising:
moving a pointer within a display screen based on operation information; and
determining whether the pointer is to be moved into a virtual screen set around the display screen, based on a state of the pointer when the pointer is moved to an edge of the display screen.

11. A program for causing a computer to execute:
a control function of moving a pointer within a display screen based on operation information; and
a determination function of determining whether the pointer is to be moved into a virtual screen set around the display screen, based on a state of the pointer when the pointer is moved to an edge of the display screen.
